(19) United States
(12) Patent Application Publication
(10) Pub. No.: US 2004/0228208 A1
(43) Pub. Date: Nov. 18, 2004

(54) Mixing vial

(75) Inventors: Mark James Papania, Lilburn, GA (US); James J. Barry, Hanover, NH (US); Mark C. Bagley, Grafton, NH (US)

Correspondence Address: KLARQUIST SPARKMAN, LLP, 121 SW SALMON STREET, SUITE 1600, PORTLAND, OR, 97204, US

(73) Assignees: The Government of the United States of America,; The Department of Health and Human Services, Centers for Disease Control and Prevention

(21) Appl. No.: 10/874,780

(22) Filed: Jun. 22, 2004

Related U.S. Application Data
(63) Continuation-in-part of application No. PCT/US03/19684, filed on Jun. 20, 2003.
(60) Provisional application No. 60/391,862, filed on Jun. 25, 2002.

(51) Int. Cl. B01F 7/00; B01F 13/00

(52) U.S. Cl. 366/197; 604/82

(57) ABSTRACT

A mixing vial for storing and mixing first and second components includes a mixing container for holding one of the components, and a supplemental container received within the mixing container for holding the other of the components separated from the first component. Manually operable release mechanism is actuatable to produce opening of the supplemental container within the mixing container to permit mixing of the previously segregated components to form a combined mixture in the mixing container.

### CROSS REFERENCE TO RELATED APPLICATION

This application is a continuation-in-part of PCT Application No. PCT/US2003/019684 filed Jun. 20, 2003, and claims benefit of U.S. Provisional Application No. 60/391,862 filed Jun. 25, 2002, both incorporated herein by reference.

### FIELD

This invention relates to a mixing vial for storing and mixing first and second components. More specifically, it relates to a mixing vial having a mixing container for holding a first component and a supplemental container for holding the second component in a sealed condition, and manually operable release mechanism for opening the supplemental container to permit mixing of the first and second components in the mixing container.

### BACKGROUND

In the medical field there are many solutions which are administered in liquid form, such as by needles and syringes, jet injectors, aerosol dispensers, or other devices. Many such solutions may need to be packaged and stored with a liquid first component separated from a second component. In the past this often has been done with separate containers which must be accessed individually and the components combined for mixing.

Some past attempts have been made to provide a single container which has multiple compartments therein for holding separated components with a sealing mechanism therebetween. Although such have provided separate container regions for segregated components and means for displacing a seal therebetween to allow mixing of the multiple components, such prior devices have not been as economical and convenient to use as may be desired.

An example of an area in which great need exists for improved storage and mixing of multiple-component mixtures is in the field of vaccination against diseases. For example, programs to vaccinate against measles require the storage of lyophilized virus separate from a sterile diluent until a time when such is needed for vaccination purposes. Near the time the mixture is needed, the two components (lyophilized virus and sterile diluent) in the previously-known systems often required reconstitution of the vaccine by drawing sterile diluent from a sealed vial (via needle and syringe) and injecting it into another sealed vial containing the lyophilized virus. The vial containing the two components (diluent and lyophilate) then is shaken to mix the components, or constituents, and achieve reconstitution of the vaccine. Thus, even if a needle-free administration technique for the vaccine subsequently is used, the reconstitution process requires the use of needles and syringes producing opportunity for contamination through the re-use of dirty needles, the need to dispose of used needles and syringes, the possibility of use of improper diluents, the possibility of measurement errors in obtaining the proper dilution, and the possibility of needle-stick injuries by workers.

Moreover, as commonly used in the field, the need for separate supply vials for vaccine and diluent requires multiple sterile containers to be ordered, transported, inventoried, coordinated and monitored.

What is needed is an improved mixing vial system for storage, transport and reconstitution of components, such as lyophilized vaccines, or other products.

### SUMMARY

The present invention is directed to a mixing vial, or apparatus, for storing and mixing first and second components and includes a mixing container for holding the first component, a supplemental container of liquid impermeable material received within the mixing container for holding the second component separated from the first component, and manually operable release mechanism for opening the supplemental container to permit mixing of the first and second components to form a combined mixture in the mixing container.

In one aspect of the invention, sealing mechanism releasably holds a first end of the supplemental container in sealed relationship adjacent a septum which closes a first end of the mixing container, and release mechanism is manually operable to shift the supplement container from its sealed relationship.

In another aspect, the supplemental container has an open end directed into the mixing container and a closure member releasably connected to and closing such end of the supplemental container, with release mechanism manually operable to force the closure member from its closure position to release component held in the supplemental container into the mixing container.

In another aspect of the invention, a mixing container having a septum closing one end thereof has a supplemental container mounted for shifting therein and biasing mechanism within the container yieldably urges the supplemental container toward the septum, such that the rim of an open mouth of the supplemental container sealingly engages the septum to permit the supplemental container to hold one component material separated from another component material held in the mixing container and a manually operable release mechanism is capable of shifting the supplemental container against the yieldable biasing force of the biasing mechanism out of its sealed condition permitting mixing of the two components.

In another aspect of the invention, a mixing container is capable of holding a first component and a supplemental container is provided in the mixing container for holding a second component, with the supplemental container having a rupturable portion and release mechanism in the form of manually operable means for breaking the rupturable portion of the supplemental container to permit mixing of the components to provide a combined mixture in the mixing container.

More specific aspects relate to features of the sealing mechanism for sealing an open end of the supplemental container, and manually actuatable operator members to cause the supplemental container to be opened to release component material held therein.

### BRIEF DESCRIPTION OF THE DRAWINGS

FIGS. 1A, 1B, 1C are views taken in cross section along the longitudinal axis of a mixing vial according to a first embodiment showing elements of the mixing vial in various operating conditions, with FIG. 1C showing the mixing vial inverted;

FIGS. 2A, 2B are views taken in cross section along the longitudinal axis of a mixing vial according to a second embodiment showing elements of the mixing vial in various operating conditions;

FIGS. 3A, 3B are views taken in cross section along the longitudinal axis of a mixing vial according to a third embodiment showing elements of the mixing vial in various operating conditions, with FIG. 3B showing the mixing vial inverted;

FIGS. 4A, 4B, 4C are views taken in cross section along the longitudinal axis of a mixing vial according to a fourth embodiment showing elements of the mixing vial in various operating conditions;

FIGS. 5A, 5B are views taken in cross section along the longitudinal axis of a mixing vial according to a fifth embodiment showing elements of the mixing vial in various operating conditions;

FIGS. 6A, 6B are views taken in cross section along the longitudinal axis of a mixing vial according to a sixth embodiment showing elements of the mixing vial in various operating conditions;

FIGS. 7A, 7B, 7C are views taken in cross section along the longitudinal axis of a mixing vial according to a seventh embodiment showing elements of the mixing vial in various operating conditions; and

FIGS. 8A, 8B, 8C are views taken in cross section along the longitudinal axis of the mixing vial according to another embodiment showing elements of the mixing vial in various operating conditions.

FIG. 9 is a perspective view of a mixing vial according to another embodiment of the invention;

FIG. 10 is an enlarged exploded view of the mixing vial of FIG. 9 showing the component parts prior to assembly;

FIGS. 11A, 11B, and 11C are views taken in cross section along the longitudal axis of the mixing vial illustrated in FIG. 9 in various operating conditions;

FIGS. 12A, 12B, 12C are views taken in cross section along the longitudal axis of a mixing vial according to a further embodiment showing elements of the mixing vial in various operating conditions; and

FIGS. 13A, 13B, 13C, 13D are views taken in cross section along the longitudinal axis of a mixing vial according to another embodiment showing elements of the mixing vial in various operating conditions.

### DETAILED DESCRIPTION

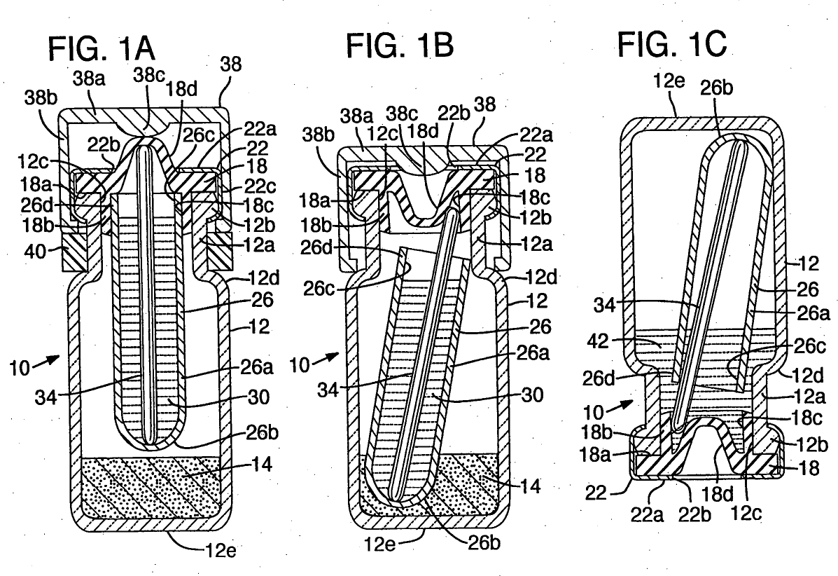

Referring to the drawings, and first more specifically to FIGS. 1A, 1B, 1C, at 10 is indicated generally a mixing vial, or apparatus, according to an embodiment of the invention. The mixing vial includes a generally conventional, substantially cylindrical mixing container 12 having a neck portion 12a and radially outwardly projecting annular rim, or lip, 12b adjacent its open end 12c. Container 12 also has an annular shoulder 12d adjacent neck 12a. The end of container 12 opposite open end 12c is closed by a bottom wall 12e. Container 12 is capable of holding a component to be mixed within the container such as lyophilate indicated generally at 14.

The open end 12c of container 12 is sealingly closed by a flexible elastomeric septum 18. Septum 18 has an outer rim with an under surface 18a which rests sealingly against the top of lip 12b. A substantially cylindrical sealing ring portion 18b depends from under surface 18a, extends inwardly of the container and has a substantially cylindrical inner surface 18c. The central portion of septum 18 indicated generally at 18d initially is bowed upwardly in the convex curved configuration illustrated in FIG. 1A. Portion 18d may be pressed downwardly to assume the downwardly curved, or concave, configuration shown in FIG. 1B as will be described in greater detail below.

Sealing septum 18 is secured in place on the open end of container 12 by a holding member 22. The holding member has a substantially planar upper portion 22a with a circular opening 22b formed therein through which central portion 18d of the septum projects and is accessible. A cylindrical skirt portion 22c of holding member 22 extends downwardly about the outer edges of septum 18 and rim 12b of container 12 and is folded inwardly under rim 12b to fixedly hold septum 18 in tight engagement with rim 12b to sealingly close end 12c of container 12.

A liquid impermeable supplemental container 26 having a generally test tube shape is received in container 12. Supplemental container 26 has substantially cylindrical sidewall 26a with a closed lower end 26b and an open upper end 26c. Open end 26c is surrounded by a neck 26d having a selected configuration, in this situation cylindrical.

The inner surface 18c of sealing ring 18b has a configuration complementary to neck 26d of container 26, such that in the position illustrated in FIG. 1A the open end portion of supplemental container 26 is frictionally gripped and held in sealing relationship in sealing ring 18b. The end rim of supplemental container 26 may be held firmly against the underside of the septum.

Supplemental container 26 is adapted to hold the other component, such as liquid, or diluent, 30 separated from the first-mentioned component 14 held in container 12.

An elongate rigid rod 34 is received in supplemental container 26 and extends from the lower end 26b of container 26 to the underside of portion 18b of septum 18. In a non-operating position illustrated in FIG. 1A, rod 34 merely rests within the confines of the supplemental container and septum such that the supplemental container continues to be held sealingly in sealing ring 18b.

An actuator cap 38 having a substantially planar outer portion, or top, 38a and depending cylindrical skirt 38b is shiftable between a non-operating position as illustrated in FIG. 1A and an operating position as illustrated in FIG. 1B. An actuating protrusion 38c is formed on the underside of top 38a to engage the upwardly bowed central portion 18d of septum 18.

A safety member, or ring, 40 is interposed between the lower end of skirt portion 38b of the actuator cap and a shoulder 12d on container 12. In the safety position for member 40 illustrated in FIG. 1A, cap 38 is prevented from being shifted downwardly from its non-operating position as illustrated in FIG. 1A. However, the safety member 40 may be physically removed (also referred to herein as moved to a release position) when it is desired to mix components in the containers. Upon removal of the safety member actuator 38 may be shifted downwardly to its operating position as illustrated in FIG. 1B.

Thus, following removal of safety member 40, cap 38 may be manually shifted downwardly, with protrusion 38c engaging upwardly bowed portion 18d of the septum and forcing it downwardly from the position in FIG. 1A toward its downwardly curved, or concave, position illustrated in FIG. 1B. As this occurs rod 34 transmits the downwardly directed forces of cap 38 and septum 18 to force supplemental container 26 from its position frictionally held in sealing ring 18b. Supplemental container 26 then is shifted downwardly to the position illustrated in FIG. 1B, such that its open end 26c is exposed to the interior of container 26 and components 14, 30 (such as a diluent and lyophilate) may be mixed together by inversion of the mixing vial and gentle shaking to produce a combined mixture 42 within container 12 as shown in FIG. 1C.

After the components have been thoroughly mixed actuator cap 38 may be removed to expose septum 18 through which a needle may be inserted to withdraw a quantity of combined mixture 42.

The mixing container 12 and supplemental container 26 may be made of glass or other material acceptable for use in such situations, with a primary requirement being that they be liquid impermeable. The septum is composed of a flexible elastomeric material, such as rubber or an acceptable plastic. Holding member 22 may be made of a metal or plastic material capable of providing sufficient holding force to maintain a sealing condition between septum 18 and lip 12b of container 12. Cap 38 and safety member 40 may be made of any appropriate material, such as plastic or metal, capable of supporting the loads which may be imposed thereon and allowing removal from the combined assembly as illustrated. Rod 34 may be glass, plastic, or metal.

In assembling the mixing vial with the components held in the containers, a first component, such as the lyophilate 14 may be produced by an appropriate process within container 12 itself, if desired. Similarly, if the lyophilate is to be held in supplemental container 24 it also could serve as the vessel in which in the lyophilate is produced. It should be recognized that either component 14 or 30 may be placed in mixing container 12 and the other of such components placed in supplemental container 24 as most appropriate for the application at hand.

After the desired component has been placed in container 12, and the second component placed in supplemental container 26, rod 34 is placed in supplemental container 26, and the open end of container 26 is inserted into sealing ring 18b and frictionally held therein. Supplemental container 26 and septum 18 then are inserted into the mouth of container 12 as illustrated in FIG. 1A and holding member 22 is secured thereon. Safety member 40 and operating cap 38 then are attached as illustrated in FIG. 1A. The assembled apparatus of FIG. 1A provides excellent separation of the components for storage or transporting, and simple release for mixing.

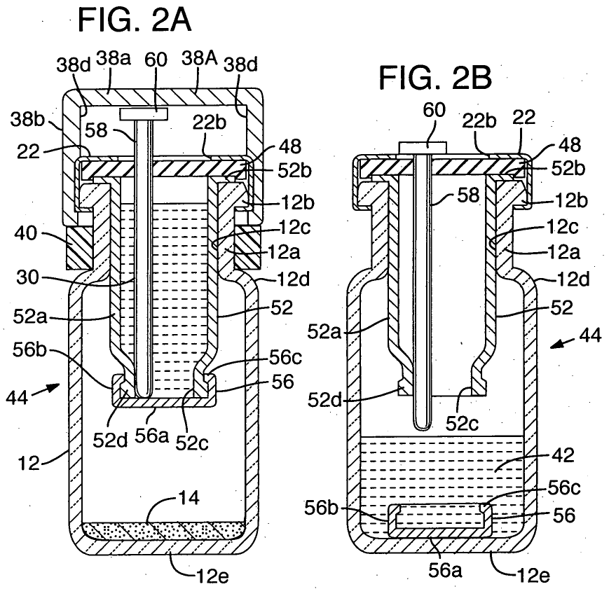

Referring to FIGS. 2A, 2B, a second embodiment is illustrated. Here a mixing vial, or apparatus, for storing and mixing first and second components is indicated generally at 44. It includes a mixing container 12 generally similar to that described above having the same configurations and portions which are similarly numbered herein.

Mixing container 12 is adapted to hold one of the two components to be mixed, such as the lyophilate 14 indicated.

A flexible elastomeric septum 48 overlies and closes off the open end of container 12. A holding member 22 similar to that previously described above is secured over septum 48 to sealingly hold it on the top of container 12. Again holding member 22 has a central opening 22b which exposes the central portion of septum 48.

An actuator cap 38A generally similar to previously described cap 38 overlies the top of the container. Cap 38A has an upper, or top plate, portion 38a with a cylindrical depending skirt 38b. This cap does not have a depending protrusion on its underside as illustrated in FIG. 1A. However, it is provided with radially inwardly protruding portions 38d which overlie the outer edges of holding member 22 to inhibit movement of cap 38A downwardly from the position illustrated in FIG. 2A.

A removable safety ring 40, as previously described above, is interposed between the lower end of cap 38A and shoulder 12d on the container to further assure that cap 38A is held in place in a raised position as illustrated in FIG. 2A.

A liquid impermeable supplemental container 52 is received in container 12 as illustrated in FIG. 2A. The supplemental container has a main body portion 52a which is substantially cylindrical in configuration with an open upper end surrounded by a radially outwardly projecting annular rim 52b. Rim 52b is sealingly captured between septum 48 and the upper rim 12b of container 12. Remainder portions of body 52a extend inwardly through neck 12a of container 12 with an open lower end portion 52c received within container 12. The open lower end 52c has a radially outwardly projecting annular rim 52d which provides a substantially continuous circular shoulder facing in the direction of rim 52b.

The supplemental, or inner, container may be made shorter than that shown in the drawings, such that it does not extend inwardly of container 12 a meaningful distance beyond the neck of container 12. Such construction would avoid the possibility that mixed materials may be trapped between the outer surface of the supplemental container and the inner wall of container 12 and not be available to be easily withdrawn.

A cap, or closure member, 56 is adapted to sealingly close the lower end 52c of container 52. Closure member 56 has a substantially planar body portion 56a and an upwardly projecting cylindrical rim 56b. An annular shoulder 56c extends radially inwardly from the top portion of rim 56b and is positioned and configured to engage the upper shoulder on rim 52d at the lower end of container 52. The rim 56b of cap 56 may be made of elastomeric material and is sufficiently flexible, or resilient, that it may be slipped on to and releasably grip the lower end portion of container 52 to sealingly close the lower end of container 52. The gripping force of the cap, however, is yieldable such that the cap may be forced from its closure position as illustrated in FIG. 2B as will be described in greater detail below.

The lower end portion of container 52 and cap 56 have a smaller outer diameter than the inner diameter of neck 12a of container 12 so they can be inserted into container 12 during assembly.

An elongate rigid actuator rod 58 extends sealingly through an opening in septum 48 and into supplemental container 52. Rod 58 has a manually engagable head 60.

When rod 58 is in its at rest position as illustrated in FIG. 2A, it applies substantially no force against cap 56, and thus cap 56 is held in mated sealing engagement with the lower end of container 52 to hold a second component, such as diluent 30 therein. Rod 58 may be manually forced downwardly as illustrated in FIG. 2B to force cap 56 from the lower end of container 52 to release diluent 30 into container 12, such that it may be mixed with lyophilate 14 to provide a combined mixture indicated generally at 42.

To actuate rod 58 to open supplemental container 52 it is necessary to remove cap 38A and manually engage head 60 to press rod 58 downwardly. In an alternate embodiment which may lack radially inwardly directed protrusions 38d on cap 38A, safety member 40 may be removed, and cap 38A pressed downwardly toward septum 48 which would act to press rod 58 downwardly. However, regardless of which method is used, cap 38A must be removed to permit access of a needle to puncture septum 48 and withdraw a quantity of combined mixture 42 therefrom for use.

Upon assembly of the apparatus illustrated in FIG. 2A, a first of the components, be it lyophilate or diluent, is placed in container 12. If desired, previously known manufacturing processes can be used wherein liquid vaccine can be introduced into container 12 and lyophilized in place.

Next, supplemental container 52 has cap 56 attached thereto, the second component, such as diluent 30 shown herein, is placed in container 52, septum 48 is placed against rim 52b, and the combined assembly of the supplemental container 52, cap 56, septum 48, and holding member 22 are assembled onto the container 12 as illustrated, with rod 58 extending through septum 48. Cap 38A and safety member 40 are applied and the container is ready for storage and shipment in the condition illustrated.

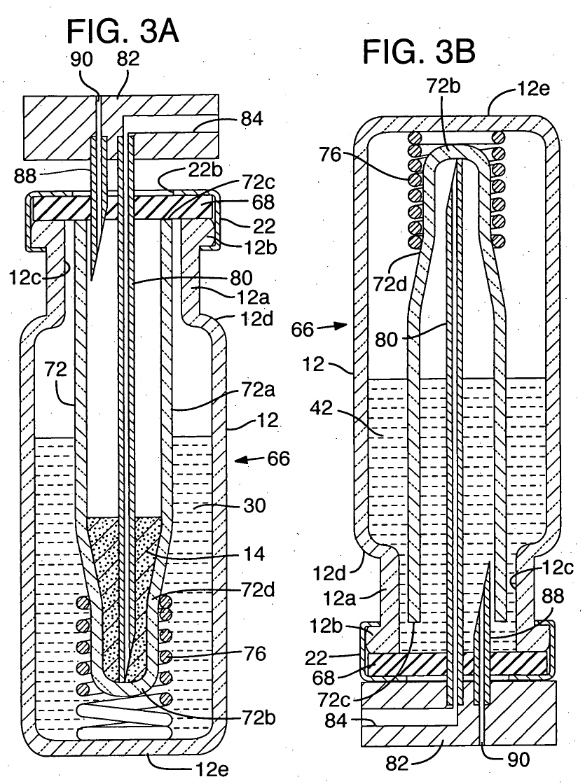

Another embodiment is illustrated FIGS. 3A, 3B. Here a mixing vial, or apparatus, for storing and mixing first and second components is indicated generally at 66.

The apparatus includes a mixing container 12 substantially similar to that previously described above, with an overlying sealing elastomeric septum 68 sealingly held at the open end of container 12 by a holding member 22 as previously described.

A liquid impermeable, substantially rigid supplemental container 72 having generally a test tube shape is held within container 12. Container 72 has a cylindrical major body portion 72a, a rounded closed lower end 72b, and a rim 72c surrounding the neck at its open mouth. A lower end portion of container 72 is somewhat necked down to provide a shoulder region 72d.

A yieldable biasing mechanism, in the form of a compression spring 76, bears at one end against the bottom, or lower end, 12e of container 12 and at its opposite end against shoulder region 72d of container 72. Spring 76 urges rim 72c of the supplemental container into sealing engagement with the inwardly facing surface of septum 68. In this position container 12 may hold one of the components to be mixed (shown here as diluent 30) and supplemental container 72 may hold the other of the components to be mixed (shown here as lyophilate 14).

An elongate rigid hollow rod 80 extends from a region outside septum 68, slidably and sealingly through an opening in septum 68, through supplemental container 72, and engages the lower end 72d. The outer end of rod 80 is secured to a head 82 which has a port 84 which communicates with the central lumen of rod 80.

A shorter needle 88 also extends sealingly and slidably through septum 68 and is secured to head 82. A second port 90 in head 82 communicates with the lumen of needle 88.

An overlying cap similar to those indicated in FIGS. 1A, 2A at 38, and 38A and an appropriate safety member as previously illustrated at 40 may be placed about head 82 and the upper portion of container 12 to seal such in a non-operating position for storage and transportation. However such additional elements have not been shown here for simplicity.

In its normal at rest state as shown in FIG. 3A, spring 76 holds rim 72c of supplemental container 72 in sealing engagement against the underside of septum 68. This effectively provides a sealed separation between components 14, 30. When it is desired to mix components 14 and 30 a user manually presses head 82 toward septum 68 as shown in FIG. 3B. This manual force is transmitted through rod 80 to supplemental container 72 which compresses spring 76 and forces rim 72c from septum 68, thus opening the mouth of supplemental container 72 to the interior of container 12. The containers then may be inverted as illustrated in FIG. 3B to allow components 14, 30 to be mixed by gentle shaking of the apparatus. The friction forces acting between rod 80 and needle 88 and the material of septum 68 should be sufficient to hold the operator head in its collapsed position as illustrated in FIG. 3B against the biasing force of spring 76, such that the mouth of supplemental container 72 would remain open. After the components have been mixed into a combined mixture 42 appropriate auxiliary apparatus may be connected to ports 84, 90 to withdraw a quantity of the combined mixture for use.

An alternate embodiment of the apparatus shown in FIGS. 3A and 3B, although not shown in the drawings, could include a solid rod 80 without a lumen, or bore, extending therethrough and port 84 would not be included. Port 90 could be a standard luer type adapter to which a syringe or other apparatus could be attached to withdraw mixed materials through needle 88. The standard luer type adapter would be capped or plugged for protection of the contents in the mixing apparatus until such time as they are to be withdrawn.

It should be recognized that a standard luer type adapter also could be used with other embodiments of the invention described herein to facilitate withdrawal of mixed materials from the apparatus.

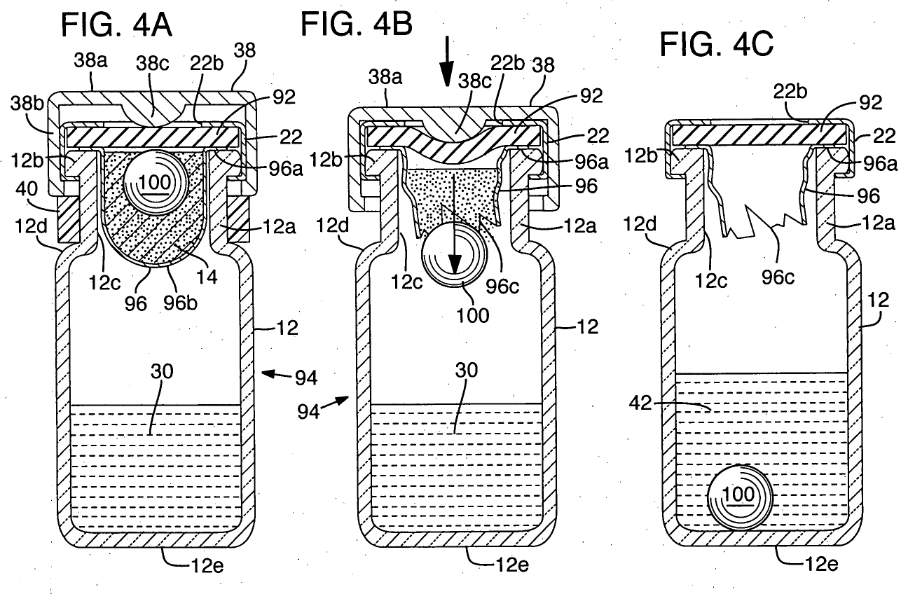

FIGS. 4A, 4B, 4C illustrate yet another embodiment. This includes a mixing vial, or apparatus, 94 for holding, storing, and mixing first and second components. The apparatus includes a mixing container 12 generally as described above. A flexible elastomeric septum 92 is held in sealing engagement over the open end of container 12 by a holding member 22 as previously described. An actuator cap 38 with substantially planar top portion 38a, depending skirt 38b, and protrusion 38c, as previously described in regard to FIG. 1A, overlies septum 92. A safety member 40 as previously described is interposed between cap 38 and shoulder 12d on container 12 to prevent shifting of cap 38 from its first non-operating position as illustrated in FIG. 4A until desired.

A liquid impermeable supplemental container 96 is received in mixing container 12. The supplemental container illustrated here has an open first end facing septum 92 with a radially outwardly extending annular rim 96a sealingly interposed between septum 92 and rim 12b of container 12. Supplemental container 96 is formed of a liquid impermeable material such as a foil-polymer composite material which has a rupturable lower end portion 96b facing into container 12 opposite its open first end. An actuator, or agitator, ball, or member, 100 rests loosely in a quantity of one of the mixture components which substantially fills supplemental container 96. In this instance the component material held in the supplemental container is lyophilate 14, and liquid diluent 30 is held segregated therefrom in container 12.

To produce mixing of components 14, 30 a user removes safety member 40 permitting cap 38 to be pressed downwardly, such that protrusion 38c engages the top of flexible elastomeric septum 92 and forces it downwardly as illustrated in FIG. 4B. This transmits the manual force applied to cap 38 through septum 92, to ball 100 and component material 14 held in supplemental container 96. The transmission of such force to the supplemental container causes the rupturable inwardly directed portion of container 96 to break, with a breach 96c therein allowing component material 14 and ball 100 to drop into container 12 as illustrated in FIGS. 4B and 4C. Container 12 then may be shaken with ball 100 assisting in the mixing of components 14, 30 to form combined mixture 42. Following mixing a needle may be inserted through septum 92 to withdraw a quantity of the combined mixture for use.

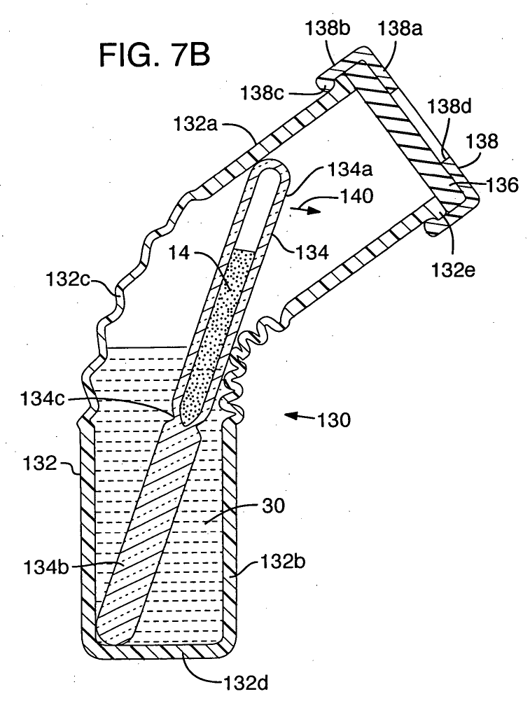

FIGS. 8A, 8B, 8C illustrate yet another embodiment. The primary components of this embodiment are substantially similar to those described above in regard to FIGS. 4A-4C, and thus are given similar numbers.

In the embodiment illustrated in FIGS. 8A-8C the component material to be mixed with the diluent indicated at 14A is a substantially solid disc-shaped tablet. It is held in a liquid impermeable supplemental container 97 closely adjacent the underside of septum 92. The radially outwardly extending annular rim portion 97a of container 97 is sealingly interposed between septum 92 and rim 12b of container 12. The lower portion 97b of the supplemental container supports tablet 14A. Again, the supplemental container 97 is formed of a liquid impermeable material, such as a foil-polymer composite material or other appropriate material, which has a rupturable portion facing into container 12.

To produce mixing of components 14A and 30 a user removes safety member 40, permitting cap 38 to be pressed downwardly, such that protrusion 38c engages the top of flexible septum 92 and forces it downwardly as illustrated in FIG. 8B. This transmits manual force to tablet 14A which causes the rupturable inwardly directed portion of container 97 to break, with a breach 97c therein allowing component material 14A to drop into container 12 as illustrated in FIG. 8B. The container then may be shaken to mix components 14A, 30 to form combined mixture 42. Removal of cap 38 following mixing allows a needle to be inserted through septum 92 to withdraw a quantity of combined mixture therefrom.

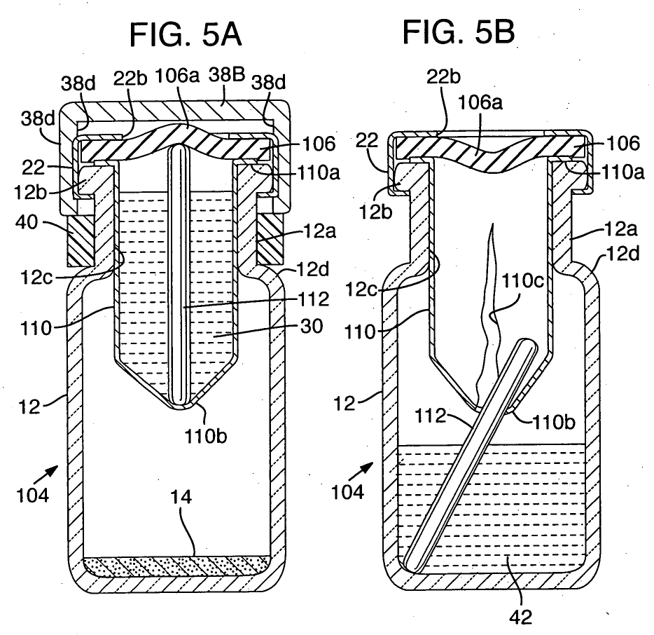

Referring to FIGS. 5A, 5B, yet another embodiment is illustrated. Here a mixing vial, or apparatus, for storing and mixing first and second components is indicated generally at 104. It includes a mixing container 12 similar to that previously described with an overlying flexible elastomeric septum 106 sealingly held to the open mouth end of container 12 by holding member 22 as previously described. The central portion 106a of septum 106 is initially bowed upwardly in a convex configuration as illustrated in FIG. 5A and may be manually forced to a downwardly curved, or concave, configuration as illustrated in FIG. 5B.

A cap 38B somewhat similar to that previously described at 38A overlies septum 106 with inwardly directed projections 38d to inhibit movement of cap 38B toward septum 106. A safety member 40 again is interposed between cap 38B and shoulder 12d of container 12.

Alternately, a cap similar to that indicated at 38 in FIG. 1A with a protrusion 38c on its underside aligned with central portion 106a of septum 106 could be used. Such cap 38 would not have projections 38d as illustrated in FIG. 5A and could act as an actuator member to be pressed against by a user to urge central portion 106a of septum 106 between its upwardly curved positions illustrated in FIG. 5A and its downwardly curved position as illustrated in FIG. 5B.

A liquid impermeable supplemental container 110 is received in container 12. The open end of container 110 adjacent septum 106 has a radially projecting annular rim 110a sealingly captured between septum 106 and rim 12b of container 12. The opposite end 10b of container 110 extends into container 12 and has a rupturable portion which may be broken, with the breach therein opening into container 12.

The supplemental, or inner, container may be made shorter than that shown in the drawings, such that it does not extend inwardly of container 12 a meaningful distance beyond the neck of container 12. Such construction would avoid the possibility that mixed materials may be trapped between the outer surface of the supplemental container and the inner wall of container 12 and not be available to be easily withdrawn.

An elongate rigid actuator rod 112 extends between central portion 106a of the septum and lower end portion 110b of the supplemental container. In its normally at rest position the rod is held as illustrated in FIG. 5A.

Upon manual force being applied to the central portion 106a of the septum inwardly toward the container, such manual force is transmitted through rod 112 to the lower end portion 110b of the supplemental container causing the rupturable portion of the supplemental container to break to produce a breach 110c. In the illustrated embodiment lyophilate 14 is held in container 12 segregated from liquid diluent 30 in supplemental container 110. Upon breaching of container 110 as illustrated in FIG. 5B, the diluent 30 and rod 112 drop into container 12 to permit shaking of the container with the rod 112 assisting in agitating and mixing the components to form combined mixture 42 therein.

Again, a quantity of the combined mixture may be withdrawn by a needle inserted through septum 106 following removal of cap 38B.

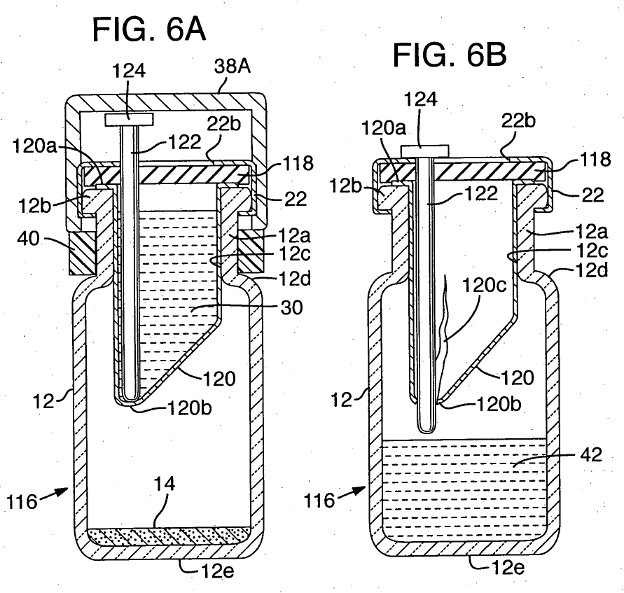

Another embodiment is illustrated in FIGS. 6A, 6B wherein a mixing vial, or apparatus, for storing and mixing first and second components is indicated generally at 116. It includes a mixing container 12 as previously described, having an overlying flexible elastomeric septum 118 sealingly held at its open end by holding member 22 as previously described.

A supplemental container 120 extends into container 12 and has a radially projecting annular rim 120a at its open end sealingly held between septum 118 and rim 12b of container 12. The lower end portion 120b of supplemental container 120 extends into and is directed inwardly of container 12.

The supplemental, or inner, container may be made shorter than that shown in the drawings, such that it does not extend inwardly of container 12 a meaningful distance beyond the neck of container 12. Such construction would avoid the possibility that mixed materials may be trapped between the outer surface of the supplemental container and the inner wall of container 12 and not be available to be easily withdrawn.

An elongate rigid rod 122 having a head 124 extends sealingly through an opening in septum 118 with the major portion of the rod received in supplemental container 120. An overlying cap similar to that described earlier at 38A and a safety member 40 as previously described are assembled as illustrated in FIG. 6A.

Upon removal of cap 38A a user may manually engage head 124 and force rod 122 inwardly from a non-operating first position as illustrated in FIG. 6A to an operating, or breaching, position illustrated in FIG. 6B. This causes force to be transmitted to the supplemental container 120 to breach a rupturable portion therein as shown at 120c in FIG. 6B which releases a component held in the supplemental container into container 12. In this case lyophilate 14 is held in container 12 and diluent 30 is held in supplemental container 120. These are mixed by shaking the container to form a combined mixture 42 illustrated in FIG. 6B.

As with all of the embodiments described herein, it should be recognized that generally either one of the components may be held in the mixing container and the other component held in the supplemental container as desired.

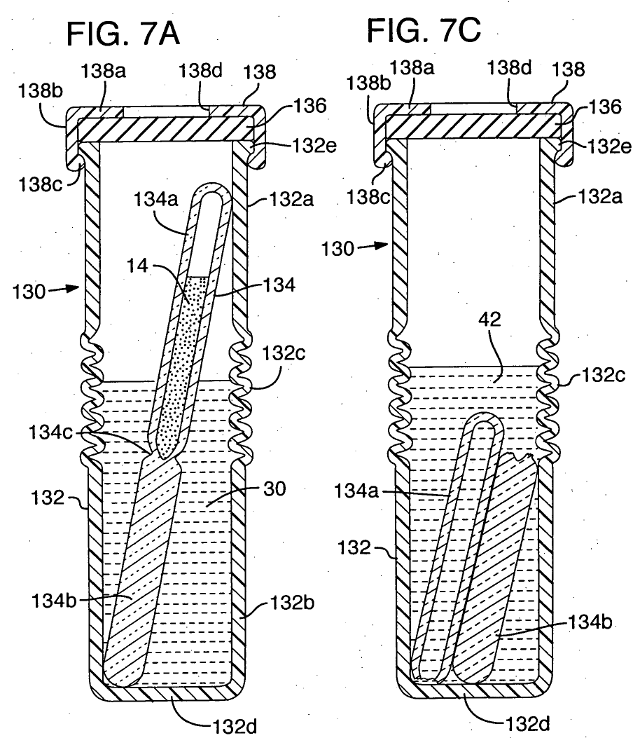

Referring to FIGS. 7A, 7B, 7C, a further embodiment is illustrated. In this embodiment a mixing vial, or apparatus, for storing and mixing first and second components is indicated generally at 130. It includes an elongate outer mixing container 132 and an elongate inner, or supplemental, container 134 received in container 132.

Mixing container 132 has substantially cylindrical upper and lower end portions 132a, 132b, respectively, which are connected by a flexible corrugated, or bellows shaped, intermediate portion 132c. The operation of flexible intermediate portion 132c will be described in greater detail below.

The lower end of container 132 is closed by a bottom wall 132d, and its upper end is open, with a radially projecting lip, rim, or shoulder 132e. A flexible elastomeric septum 136 is sealingly attached to the open upper end of container 132 by a holding member 138 having a substantially planar upper portion 138a, a cylindrical depending skirt 138b, and a radially inwardly projecting rim 138c which engages rim 132e on container 132 to sealingly secure septum 136 to the top of container 132. A central opening 138d provides access to septum 136 through which a needle many be inserted into container 132 to withdraw materials therefrom.

Supplemental container 134 comprises an elongate ampoule which has sufficient length that its lower end rests on bottom wall 132d and its upper end extends into upper portion 132a of container 132. The container 134 is made of a frangible material, such as glass, having a hollow portion 134a which is connected to a solid portion 134b through a weakened intermediate section 134c.

In use, one of the components to be mixed, is held in container 132 (here diluent 30) and the other component to be mixed (here lyophilate 14) is held in the hollow portion 134a of supplemental container 134. The material of which supplemental container 134 is made is liquid impermeable, and thus the two components are segregated from each other during storing and handling in the manner illustrated in FIG. 7A.

As previously mentioned, intermediate portion 132c of container 132 is flexible. In its normally at rest position container 132 assumes a desired position with its upper and lower portions 132a, 132b disposed in a selected angular relation to each other. In the illustrated embodiment the angular relation is such that the two portions, or sections, 132a, 132b, are substantially aligned longitudinally of the container. However, other angular dispositions may be chosen as desired.

The flexible intermediate region 132c permits flexing, or bending, of the upper and lower portions of container 134 relative to each other as generally illustrated in FIG. 7B. As the upper and lower portions of container 132 are bent relative to each other as illustrated in FIG. 7B the lower end of supplemental container, or ampoule, 134 is held against a sidewall of the lower portion of the container 132a and the upper end is forced to the side in the direction of arrow 140, with an intermediate region of the container bearing against an intermediate portion of the supplemental container which causes it to break at weakened section 134c as illustrated in FIG. 7C. When the supplemental container breaks as illustrated the component held within the supplemental container is free to mix with the component previously held segregated therefrom in container 132 such that they mix to form a combined mixture 42.

A needle then may be inserted through septum 136 to withdraw a quantity of the combined mixture therefrom.

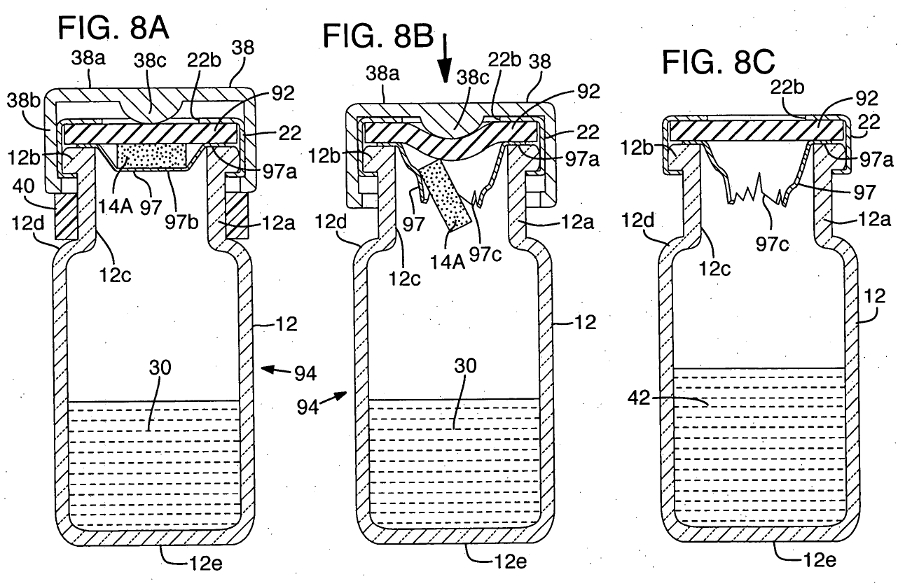

Referring to FIGS. 9, 10, 11A, 11B, and 11C, a further embodiment is illustrated. Here a mixing vial, or apparatus, for storing and mixing first and second components is indicated generally at 160. It includes an outer mixing container 12 generally similar to that described above having the same general configurations and portions, which are similarly numbered herein.

Mixing container 12 is adapted to hold one of the two components to be mixed, such as the lyophilate 14 indicated.

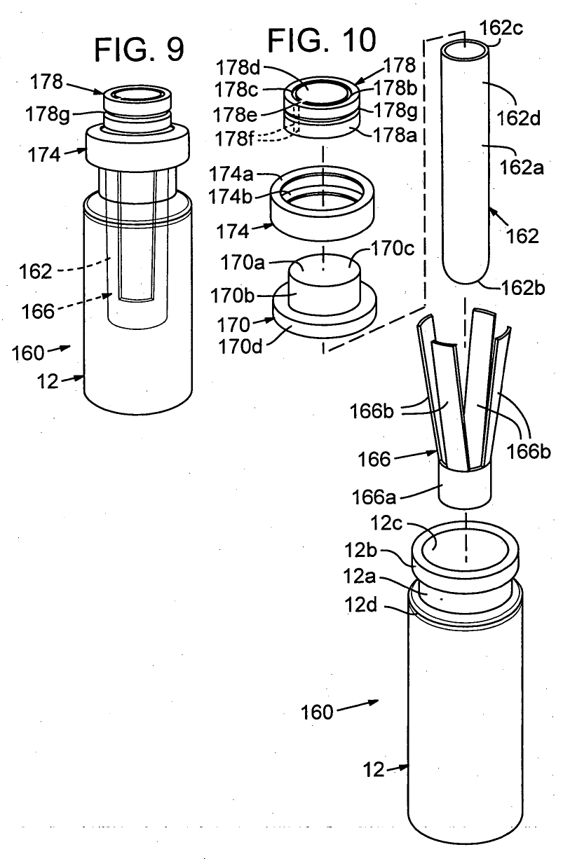

Referring to FIG. 10 in which the individual components are shown in exploded view, it will be seen that a liquid impermeable supplemental, or inner, container 162 having a generally test tube shape is provided. Supplemental container 162 generally has a cylindrical sidewall 162a with a closed lower end 162b, an open upper end 162c, and a neck portion 162d adjacent open end 162c.

Underlying container 162 in FIG. 10 is an inner container carrier 166 which has a substantially cup shaped lower end portion 166a into which the lower end portion 162b of container 162 may be press fit to frictionally hold container 162 in carrier 166.

Carrier 166 may be made of a plastic material having a plurality of elongate upwardly projecting holding fingers 166b which, when free of any encumbrance, are yieldably biased outwardly and assume an outwardly diverging configuration extending upwardly from lower portion 166a, as seen in FIG. 10.

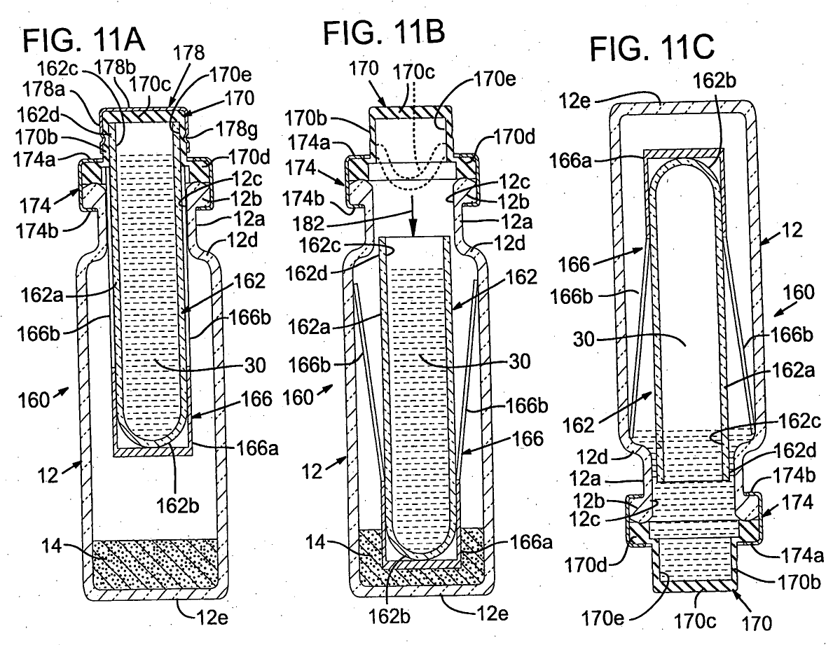

The overall length of carrier 166 is somewhat shorter than the length of inner container, 162, such that when the inner container 162 is held in carrier 166 (as possibly best illustrated in FIG. 11B) the upper neck portion of container 162 extends above the upper ends of fingers 166b.

Still referring to FIG. 10, the mixing vial assembly further includes a somewhat hat shaped elastomeric cap 170. Cap 170 as seen in FIGS. 10, 11A, and 11C has a central inverted cup shaped portion 170a having a cylindrical sidewall 170b and a substantially flat top portion 170c. A lower annular rim 170d extends circumferentially about and radially outwardly from the bottom of sidewall 170b. A cylindrical pocket 170e is formed in the under, or inner, portion of cap 170. The cap may be formed of suitable rubber or flexible plastic material.

As possibly best seen in FIGS. 11A-11C rim 170d is configured to rest on and sealingly engage the upper surface of annular rim, or lip, 12b adjacent open end 12c of mixing container 12. Cap 170 acts both as a sealing septum and a portion of the operator mechanism as will be described in detail below.

Cap 170 is held in sealing engagement against the annular rim 12b of the mixing container by a holding member, or ring, 174. The holding member, or ring, 174 may be a metallic ring which is slipped down and over rim 170d of cap 170 and annular rim 12b of mixing container 12 and then has its upper and lower rims 174a, 174b crimped inwardly about the upper surface of rim 170d and the lower surface of annular rim 12b to press rim 170d into tight sealing engagement with rim 12b.

A tear-off crimp ring, or member, 178 is configured to fit over upper portion 170a of cap 170 as will be described in greater detail below. Crimp ring 178 has a cylindrical sidewall 178a and a top wall 178b. Top wall 178b is cut through in an incomplete circle indicated generally at 178c leaving a center tab portion 178d attached to remainder portions thereof by a segment 178e. Sidewall 178a is vertically scored, as indicated generally by the two dotted lines 178f, such that tab portion 178d may be lifted from remainder portions of the ring, pulled to the left about segment 178e, and as it is pulled further to the left in FIG. 10 pulls apart scored portions 178f allowing the upper crimp ring to be removed from cap 170 when desired.

In the assembled configuration, as shown in FIG. 11A, upper crimp ring 178 is fit over upper section 170a of cap 170 and a radially inwardly directed circumferential crease 178g is formed fully about sidewall 178a.

In assembled configuration mixing vial 160 is generally as illustrated in FIGS. 9 and 11A. Mixing container 12 has lyophilate 14 therein. The inner container 162 has liquid, or diluent, 30 placed therein, and the upper neck portion 162d of inner container 162 is inserted into the pocket 170e in the under side of cap 170, as illustrated in FIG. 11A. Carrier 166 is press fit onto the bottom of inner container 162 with its elongate fingers 166b extending upwardly along the sidewall 162a of container 162. Multiple fingers 166b thus are arrayed circumferentially about container 162.

Upper crimp ring 178 without crease 178g therein is applied over cap 170 following insertion of inner container 162 into pocket 170e of the cap. After application of the upper crimp ring to the cap crease 178g is formed therein which provides a radially inwardly directed force to increase the frictional grip of cap 170 on the upper neck portion 162d of inner container 162. This acts as a sealing mechanism holding the supplemental container in sealing engagement. This is to assure that the inner vial will be tightly sealed to prevent leakage of moisture from the diluent to the lyophilate during transport and storage. The sidewall 178a of the crimp ring also acts as a holding portion to inhibit flexing of the cap inwardly until ring 178 is removed.

Cap 170 is seated against the upper rim 12b of container 12 with carrier 166 and container 162 extending downwardly through the neck 12a of container 12 into the interior thereof. Holding ring 174 is crimped onto the engaging rims of cap 170 and container 12 as illustrated in FIG. 11A to sealingly hold them together. As best seen in FIG. 11A, in the initially assembled state fingers 166b are held by neck 12a closely adjacent sidewall 162a, in what is referred to herein as a non-deployed position.

To actuate the mixing vial illustrated in FIGS. 9-11C, the user lifts tab 178d on the upper crimp ring and tears the upper crimp ring apart so that it may be removed from the assembly. Following removal of the upper crimp ring as shown in FIG. 11B, the elastomeric cap 170 may be manually depressed, or flexed, inwardly toward the mixing container, by the user, which forces inner container 162 and carrier 166 downwardly into the inner chamber of mixing container 12 in the direction of arrow 182. Since upper crimp ring 178 has been removed the frictional holding force of cap 170 on inner container 162 has been reduced permitting release of the inner container from the cap. Thus a manually operable release mechanism is provided.

As illustrated in FIG. 11B, as the fingers 166b of carrier 166 pass below neck 12a of container 12 they expand, or spring, outwardly into a deployed position against the inner walls of container 12.

To mix the liquid and lyophilate, the entire assembly is inverted as illustrated in FIG. 11C such that liquid may flow out of inner container 162 to mix with the lyophilate 14. Fingers 166b engage the inner portions of shoulder 12d of container 12 to act as restraining mechanism and prevent the inner vial from falling back in a direction opposite arrow 182 fully into the neck of the mixing container. The fingers prevent the inner container 162 from returning to sealing engagement with cap 170. As seen in FIG. 11C, a space is provided between the neck 12a of the mixing container and the neck portion 162d of inner container 162 allowing movement of fluid and lyophilate therebetween.

The mixing vial 160 is not necessarily held in its fully inverted position as illustrated in FIG. 11C when shaken to mix the materials. Instead, the mixing vial may be turned on its side and shaken. Regardless of the position in which the mixing vial is oriented during shaking to mix the materials within the container, the carrier 166 and its outwardly projecting fingers 166b inhibit direct contact between the inner container 162 and mixing container 12 to reduce potential breakage or chipping during mixing.

Once the material has been fully mixed the mixing vial may be inverted as illustrated in FIG. 1C. A needle or prong may be inserted by piercing the elastomeric cap 170, which serves as a septum, to withdraw mixed material therefrom.

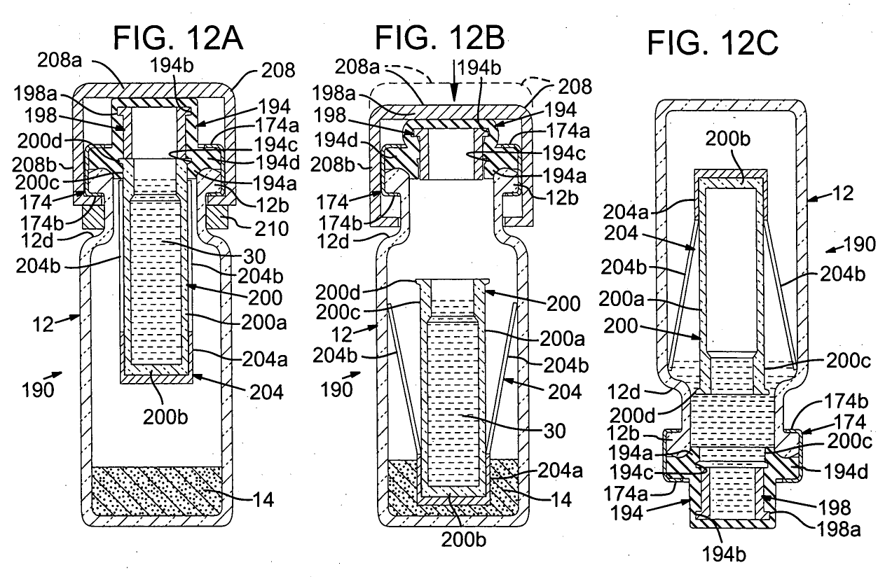

Referring to FIGS. 12A, 12B, 12C, yet another embodiment of the invention is illustrated. At 190 is indicated generally a mixing vial, or apparatus, according to this embodiment of the invention. It includes a mixing container 12 generally similar to that described previously having similar configurations and portions which are similarly numbered herein. Mixing container 12 is adapted to hold one of the two components to be mixed, such as the lyophilate 14 indicated.

Resting sealingly atop annular rim, or lip, 12b of container 12 is a hat shaped cap 194 having somewhat the same configuration as illustrated and described previously for cap 170. This cap differs in that it has a lower portion 194a which extends a short distance downwardly into the neck 12a of the container and has a pair of vertically spaced apart annular groves, or channels, 194b, 194c, defined therein.

Cap 194 has an annular rim 194d which is sealingly held against the upper rim of container 12 by a holding member, or rim, 174 as previously described regarding FIGS. 9-11C.

A generally cylindrical pusher ring, or thimble, also referred to as an operator member, 198 made of a substantially rigid material, such as hardened plastic, is configured to fit slidably within the interior of cap 194 as illustrated. Ring 198 has a projecting annular rim 198a at its upper end which is held in annular groove 194b. The lower end of ring 198 is spaced a short distance above annular groove 194c in cap 194.

A liquid impermeable inner, or supplemental, container 200 has a cylindrical sidewall 200a, a bottom 200b, and an upper end, or neck, 200c having a radially outwardly projecting annular rim 200d which is received in annular grove 194c in cap 194. A carrier 204 similar to that previously described at 166, has a substantially cup shaped cylindrical lower portion 204a and a plurality of elongate upwardly projecting elongate fingers 204b.

Inner container 200 is press fit into the lower cup shaped portion 204a of carrier 204 such that the two move together in the mixing vial. Fingers 204b have such length that they stop short of the underside of cap 194 when inner container 200 is held as illustrated in FIG. 12A.

Supplemental, or inner, container 200 is adapted to hold the second mixing component, such as liquid, or diluent, 30 separated from the first-mentioned component 14 held in container 12.

An actuator cap 208 having substantially planar outer portion, or top, 208a and a depending cylindrical skirt 208b is shiftable between a non-operating position as illustrated in FIG. 12A and an operating position as illustrated in FIG. 12B.

A safety member, or ring, 210 is interposed between the lower end of skirt portion 208b and shoulder 12d on container 12. In the safety position for member 210 illustrated in FIG. 12A, cap 208 is prevented from shifting downwardly from its non-operating position as illustrated. However, the safety member 210 may be removed (also referred to herein as removed to a release position) when it is desired to mix components in the containers. Upon removal of safety member 210 actuator member 208 may be shifted manually downwardly to its operating position as illustrated in 12B.

As the actuator cap 208 is pressed downwardly, the upper portion of cap 194, due to its being constructed of an elastomeric material, is flexed downwardly as shown in FIG. 12B to shift ring 198 downwardly which presses inner container 200 downwardly to release it from its position held in grove 194c so that it falls into mixing container 12 as illustrated in FIG. 12B. Elongate fingers 204b on carrier 204 are yieldably biased outwardly so that they will spring outwardly into deployed positions as shown in FIG. 12B. Upon inversion of mixing vial as illustrated in FIG. 12C to mix the liquid and the lyophilate, fingers 204b engage inner portions of shoulder 12d of the mixing container to inhibit return of container 200 to engagement with the sealing mechanism of cap 194 to permit mixing of the lyophilate and liquid. Again, a needle or probe may be inserted through the top portion of cap 194 to withdraw mixed solution from the mixing vial.

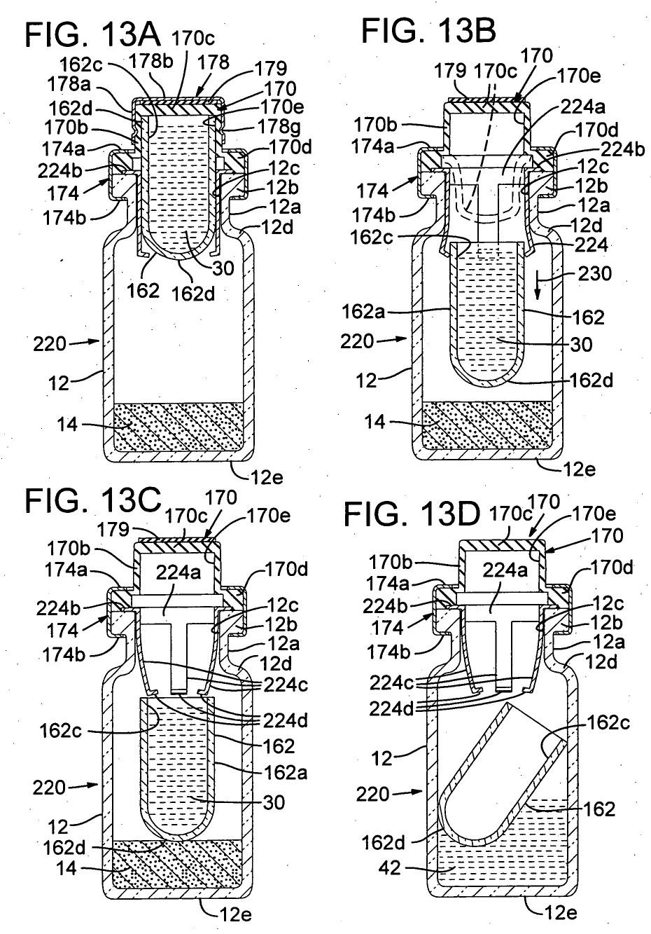

Referring to FIGS. 13A-13D, a further embodiment is illustrated. At 220 is indicated generally a mixing vial, or apparatus, according to this embodiment of the invention. It includes a mixing container 12 generally similar to that described previously having similar configurations and portions which are similarly numbered. Further, it has a supplementary container 162, cap structure 170, a holding member, or ring, 174, and a tear off crimp ring, or member, 178 similar to those previously described in relation to FIGS. 9-11C. These components have configurations and portions similar to those previously described in relation to FIGS. 9-11C and are similarly numbered herein.

An adhesive peel-off disk 179 is releasably adhered to the top of cap structure 170. As seen in FIG. 13A, it is held between cap 170 and crimp ring 178, and remains in place (as seen in FIGS. 13B, 13C) until manually removed (see FIG. 13D).

Mixing container 12 is adapted to hold one of the two components to be mixed, such as a lyophilate 14, and supplementary container 162 is adapted to hold the other of the two components to be mixed, such as a liquid, or diluent, 30.

In the embodiment illustrated in FIGS. 13A-13D, restraining mechanism indicated generally at 224 is operable to inhibit return of the supplemental container to a sealing position following release.

Describing restraining mechanism 224 in greater detail, it comprises an annular ring, or base, 224a with a radially projecting annular rim 224b extending about its upper edge. A plurality of elongate restraining members, or fingers, 224c are spaced apart circumferentially about base 224a, and extend downwardly therefrom. Each of fingers 224c has a radially inwardly projecting lip 224d at its lower end. The lower end portions of fingers 224c act as engaging portions.

Fingers 224c are flexible and have an at-rest, or deployed, configuration, or position, as best illustrated in FIGS. 13C, 13D.

As illustrated in assembled position rim 224b rests atop upper rim 12b of container 12 with remainder portions of base 224a and depending fingers 224c nested within the neck 12c of mixing container 12. Fingers 224c extend axially inwardly from the open end of container 12 toward its closed end 12e beyond shoulder 12d. Thus, the lower ends of fingers 224c extend somewhat freely into the wider portion of mixing container 12 to allow outward flexing thereof as shown in FIG. 13B as will be described in greater detail below.

The apparatus, or mixing vial, 220 is assembled in a manner very similar to that previously described for the embodiment illustrated in FIGS. 9-11C. Explaining further, lyophilate 14 is placed in mixing container 12 and liquid, or diluent, 30 is placed in inner container, or supplementary container, 162. Restraining member 224 is inserted in the neck of mixing container 12 with fingers 224c extending downwardly through the neck of container 12 and annular rim, or base 224a resting against the inner surface of neck 12c. Rim 224b rests atop lip 12b of container 12.

The upper neck portion 162d of container 162 is inserted into pocket 170e on the underside of cap 170, which has disk 179 affixed to the top thereof. Upper crimp ring 178 then is placed atop cap 170 following insertion of inner container 162 and annular crease 178g is formed therein which provides a radially inwardly directed force to increase the frictional grip of cap 170 on inner container 162. This acts as sealing mechanism holding the supplemental container in sealing engagement. This assembly then is set on container 12 with container 162 inserted downwardly through base 224a and between multiple fingers 224c. As is seen in FIG. 13A, when container 162 is inserted between fingers 224c their outer, or lower, end portions are biased outwardly to the position illustrated in FIG. 13A in what is referred to herein as a non-deployed position or state.

Cap 170 is seated against the upper rim 12b of container 12 with container 162 extending downwardly through neck 12c and through base 224a and fingers 224c. Fingers 224c thus are held by container 162 in their non-deployed positions. Holding ring 174 is placed thereon and crimped into engagement with the rims of cap 170 and container 12 as illustrated to sealingly hold them together.

To actuate the mixing vial illustrated in FIGS. 13A-13B, a user removes crimp ring 178, and manually depresses, or flexes, elastomeric cap 170 inwardly of the mixing container toward the dashed line position illustrated for 170c in FIG. 13B. This forces inner container 162 downwardly into the inner chamber of mixing container 12 in the direction of arrow 230 such that it moves along a release path from the sealing position illustrated in FIG. 13A toward the release position illustrated in FIG. 13C. Since the upper crimp ring 178 has been removed and the frictional force holding container 162 in cap 170 has been reduced, manual release is possible as described.

Disk 179 covers the top of cap 170 throughout this part of the procedure to maintain the top of cap 170 sterile.

As illustrated in FIG. 13B, as the inner container is moved inwardly (or downwardly), the lower end portions of fingers 224C are biased radially outwardly allowing container 162 to pass therethrough. If the manual pressing of cap 170 does not affect full passage of container 162 through fingers 224, a slight shaking of the container will release container 162 from the lower ends of fingers 224.

As the container reaches the position illustrated in FIG. 13C, the radially inwardly directed yieldable biasing forces on fingers 224c causes them to move radially inwardly toward the position illustrated in FIG. 13C to what is termed a deployed state. In this state they are positioned in the release path of the supplemental container to engage the supplemental container and act to prevent container 162 from returning to its sealed condition in the neck of the container and cap 170. Thus, the inner container 162 may be shaken inside mixing container 12 as illustrated in FIG. 13D such that diluent 30 may mix with lyophilate 14 to provide a mixture which may be withdrawn from the apparatus by a needle inserted through elastomeric cap 170. Disk 179 is peeled off (as seen in FIG. 13D) to provide a sterile region atop cap 170 through which a needle may be inserted.

Fingers 224c prevent container 162 from returning to a position near the neck of container 12. Thus, when container 12 is inverted to have fluid withdrawn, container 162 does not impede removal of fluid.

It should be recognized also that container 162 in the illustrated embodiment is long enough axially that it is prevented from inverting fully (i.e. it will not tumble end-over-end) and thus the open ended mouth of container 162 will continue to be directed generally toward the open end of container 12. This assures that fluid will not be held in container 162 when container 12 is inverted.

Each of the embodiments illustrated provides apparatus in which two components may be stored and transported in segregated separate compartments in one compact sterile package. Reconstitution, or mixing, of the components is easily accomplished by simple manual manipulation of the apparatus to allow mixing the components within the package itself. The reconstituted, or mixed, components can be used with aerosol devices, jet injectors that draw mixture from a vial, conventional needles and syringes which withdraw material from the containers, or other devices.

The mixing vial system of the invention allows the use of a standard outer container of glass or other appropriate material and various types of supplementary containers to create separate liquid impermeable inner storage compartments. The separate components are segregated by impermeable barriers. When mixing, or reconstitution, is desired a guard, or safety, feature is disabled, or removed, and simple hand motion serves to produce opening of one of the containers relative to the other to permit mixing within the sterile environment of the container.

The invention as set out herein provides simplicity, in that multiple vials are not needed for multiple components which need to be mixed. No syringes or needles are required for transferring components from one container to another for mixing, as has been required in some prior systems. A simple manual motion is capable of initiating a mixing sequence.

Further, pre-measured quantities of components may be packaged in the mixing container and supplemental container whereby the components are properly matched both as to the component materials themselves and the quantities to be mixed. This prevents mistakes in both materials and proportions upon mixing. Further the system as disclosed herein provides a very rapid means for reconstituting, or mixing, components in a safe manner.

The system permits use of a mixing vial which is substantially similar in size and shape to current vials used for storing and transporting medical components and is scalable from single to multi-dose sizes.

Where the lyophilate may need to be kept cool to retain its viability, such can be accomplished more easily by being packaged in the same container with a mass of cold diluent while maintaining the two segregated until such time as mixing is desired.

In several of the embodiments illustrated, the mixing container and supplemental container may be made of glass or other liquid impermeable material commonly acceptable in medical uses. Where rupturable materials are required, such materials may include a foil-polymer composite container or other liquid impermeable materials which will provide sufficient strength to maintain separation between the component parts during storing and travel, yet which may be ruptured to provide mixing of the component parts by manual actuation as described previously. The septums disclosed may be molded of a two-part silicon rubber, though other types of rubber or appropriate elastomeric materials may be used as appropriate for the components and conditions under which the container is to be used. The actuating rods and balls described may be made of glass, stainless steel, or other materials appropriate for the components to be mixed and to maintain sterile conditions.

While several embodiments have been disclosed herein, it should be apparent to those skilled in the art that variations and modifications are possible without departing from the spirit of the invention as set out in the claims following.

1. A mixing vial for storing and mixing first and second components, at least one of which components is a liquid, said mixing vial comprising
a mixing container for holding said first component, said mixing container having first and second ends with an opening at its first end,
a septum sealing said first end,
a liquid impermeable supplemental container received within said mixing container for holding the second component separated from said first component, said supplemental container having an open first end,
sealing mechanism closing said first end of the supplemental container preventing mixing of said first and second components, and
manually operable release mechanism movable between a non-operating first position wherein said sealing mechanism maintains closure of said first end of the supplemental container and an operating second position producing opening of said first end of the supplemental container to permit mixing of said first and second components to form a combined mixture in said mixing container.

2. The mixing vial of claim 1, wherein said septum comprises a puncturable seal to permit entry of a needle to said mixing container to withdraw a quantity of said combined mixture.

3. The mixing vial of claim 1, wherein said septum comprises an elastomeric member.

4. The mixing vial of claim 1, wherein said sealing mechanism comprises means for releasably holding the first end of said supplemental container in sealing relationship adjacent said septum.

5. The mixing vial of claim 1, wherein said supplemental container has a neck portion of selected configuration adjacent its first end and said sealing mechanism comprises a sealing member having a configuration complementary to said configuration of said neck portion operable to sealingly engage said neck portion.

6. The mixing vial of claim 5, wherein said sealing member comprises a sealing ring extending from said septum into said mixing container and releasably holding the neck portion of the supplemental container.

7. The mixing vial of claim 6, wherein said sealing ring comprises an elastomeric member encircling and frictionally gripping said neck portion.

8. The mixing vial of claim 6, wherein said septum is flexible inwardly toward said mixing container and said release mechanism comprises an operator member interposed between said septum and said supplemental container operable to shift said supplemental container from its position held by said sealing ring upon flexing of said septum.

9. The mixing vial of claim 8, wherein said supplemental container has a closed second end opposite said first end and said operator member comprises an elongate rigid member extending between said second end of the supplemental container and said septum which is operable to transmit force from inward flexing of said septum to said supplemental container to shift said supplemental container out of said sealing ring.

10. The mixing vial of claim 5, wherein said release mechanism comprises an elongate release member extending sealingly through said septum, said release member being manually shiftable between a first position in which the supplemental container remains in sealing engagement with said sealing member and a second position engaging the supplemental container and shifting it away from sealing engagement with the sealing member.

11. The mixing vial of claim 1, wherein said supplemental container has a neck portion of selected configuration adjacent its first end, said sealing mechanism comprises a sealing member having a configuration complementary to said neck portion configuration operable to sealingly engage said neck portion, said septum is flexible inwardly toward said mixing container, and said release mechanism comprises on operator member interposed between said septum and supplemental container operable to shift the neck portion of said supplemental container from sealing engagement with said sealing member upon inward flexing of said septum.

12. The mixing vial of claim 11, wherein said supplemental container and said operator member are substantially rigid.

13. The mixing vial of claim 11, wherein said sealing member comprises an elastomeric sealing ring encircling and frictionally gripping said neck portion.

14. The mixing vial of claim 11, wherein said septum has a normally outwardly bowed configuration and is capable of being flexed to an inwardly bowed configuration to produce maximum travel for said release member.

15. The mixing vial of claim 14, wherein said supplemental container has a closed second end opposite said first end and said operator member comprises an elongate member extending between said second end of the supplemental container and said septum operable to transmit force from inward flexing of said septum to said supplemental container to shift said supplemental container out of said sealing relationship.

16. The mixing vial of claim 11, wherein said release mechanism comprises an actuator cap overlying said septum and manually shiftable between a non-operating first position and an operating second position engaging said septum and flexing it inwardly.

17. The mixing vial of claim 16, wherein said actuator cap is mounted on said mixing container for movement in one direction for pressing inwardly on said septum and which has a protrusion on a portion thereof facing said septum operable to engage the septum and flex it inwardly on movement of said actuator cap in said one direction.

18. The mixing vial of claim 16, which further comprises a safety member shiftable between a safety position and a release position operable in said safety position to inhibit movement of said actuator cap from said first position to said second position, and in said release position permits such movement of said actuator cap.

19. The mixing vial of claim 1, wherein said supplemental container has an open mouth at a first end thereof with a surrounding rim configured to rest in sealing engagement with an inwardly facing surface of said septum, and said sealing mechanism comprises biasing mechanism in said mixing container engaging and yieldably biasing said supplemental container toward said septum with said rim held in sealing engagement with the septum.

20. The mixing vial of claim 19, wherein said biasing mechanism comprises a spring interposed between said second end of the mixing container and the supplemental container.

21. The mixing vial of claim 20, wherein said supplemental container has a shoulder formed thereon facing in the direction of said second end of the mixing container and said spring engages said shoulder.

22. The mixing vial of claim 19, wherein said release mechanism comprises an elongate release member which is manually shiftable between a first position in which the supplementary container remains in sealing contact with said septum and a second position engaging the supplementary container and shifting it away from sealing engagement with the septum against the biasing force of the biasing mechanism.

23. The mixing vial of claim 22, wherein said release member extends into said supplemental container, engages the second end of the supplemental container and on shifting of the release member from its first to its second positions moves the supplemental container to an open position.

24. The mixing vial of claim 19, wherein said release mechanism comprises an elongate release member extending sealingly through said septum, said release member being manually shiftable between a first position in which the supplemental container remains in sealing engagement with said septum and a second position engaging the supplemental container and shifting it away from sealing engagement with the septum against the biasing force of the biasing mechanism.

25. The mixing vial of claim 24, wherein said release member extends into said supplemental container, engages the second end of the supplemental container and on shifting of the release member from its first to its second positions moves the supplemental container to an open position.

26. The mixing vial of claim 25, wherein said release member comprises an elongate hollow rigid rod having an inner end disposed within said mixing container and an outer end disposed outside the mixing container and a manually engagable actuator member is connected to the outer end of said rod, said actuator member being manually shiftable from a normally at rest position spaced from said septum toward said septum to move said rod from its first toward its second positions.

27. The mixing vial of claim 26, which further comprises a hollow fluid withdrawing member which is shorter than said rod, said withdrawing member extending sealingly through said septum and into said mixing container, said withdrawing member permitting withdrawal of a quantity of combined mixture from said mixing container.

28. The mixing vial of claim 1, wherein said first end of said supplemental container faces into said mixing container, and said sealing mechanism comprises a closure member releasably connected to and closing said first end of the supplemental container.

29. The mixing vial of claim 28, wherein said release mechanism comprises an elongate actuator rod extending sealingly through said septum, said rod being mounted for shifting between a non-actuating first position wherein said closure member maintains a closure position on said first end of said supplemental container and a second position engaging and forcing said closure member from said closure position.

30. The mixing vial of claim 28, wherein said supplemental container has a neck portion adjacent its open first end and said closure member comprises a rim portion encircling and frictionally engaging said neck portion.

31. The mixing vial of claim 30, wherein said rim portion comprises a ring of elastomeric material.

32. The mixing vial of claim 30, wherein said neck portion has a radially outwardly projecting first shoulder and said rim portion has a radially inwardly projecting second shoulder positioned to engage and grip said first shoulder when said closure member is in its closure position.

33. The mixing vial of claim 28, wherein said supplemental container has an open second end opposite said first end of the supplemental container, said second end of the supplemental container being sealingly closed by said septum.

34. The mixing vial of claim 28, wherein said release mechanism comprises an elongate manually operable actuator rod extending into said supplemental container, said rod being mounted for longitudinal shifting between a non-actuating first position wherein said closure member maintains a closure position on said first end of said supplemental container and a second position engaging and forcing said closure member from said closure position.

35. A mixing vial for storing and mixing first and second components said mixing vial comprising
a mixing container for holding said first component, said mixing container having first and second ends with an opening at its first end,
a septum sealing said first end, said septum comprising an elastomeric member having a normally outwardly bowed configuration and capable of being manually flexed inwardly toward said mixing container,
a supplemental container received within said mixing container for holding the second component, said supplemental container having an open first end, a closed second end opposite said first end, and a neck portion of a selected configuration adjacent its said first end,
sealing mechanism closing said first end of the supplemental container preventing mixing of said first and second components, said sealing mechanism comprising an elastomeric sealing ring extending inwardly from said septum into said mixing container having a configuration complementary to said configuration of the neck of the supplemental container and encircling and frictionally gripping said neck portion to releasably and sealingly hold the supplemental container adjacent said septum,
manually operable release mechanism movable between a non-operating first position wherein said sealing mechanism maintains closure of said first end of the supplemental container and an operating second position producing opening of said first end of the supplemental container to permit mixing of said first and second components to form a combined mixture, said release mechanism comprising an elongate rigid member extending between said second end of said supplemental container and said septum operable to transmit force from inward flexing of said septum to said supplemental container to force said supplemental container out of said sealing ring,
an actuator cap overlying said septum and manually shiftable between a non-operating position and an operating position engaging said septum and flexing it inwardly, and
a safety member shiftable between a safety position and a release position, said safety member operable in said safety position to inhibit movement of said actuator cap from said first position to said second position, and in said release position permits such movement of the actuator cap.

36. A mixing vial for storing and mixing first and second components, said mixing vial comprising
a mixing container for holding said first component, said mixing container having first and second ends with an opening at its first end,
a septum sealing said first end,
a supplemental container for holding the second component, said supplemental container being received within said mixing container having an open first end facing into said mixing container and a second end facing and sealed by said septum, said supplemental container having a neck portion adjacent its said first end,
sealing mechanism comprising a closure member releasably connected to and closing said first end of the supplemental container to prevent mixing of said first and second components, said closure member having an elastomeric rim portion configured to encircle and frictionally engage said neck portion, and
manually operable release mechanism movable between a non-operating first position wherein said sealing mechanism maintains closure of said first end of the supplemental container and an operating second position in which it forces at least a portion of said closure member to release from said supplemental container to open said first end of the supplemental container to permit mixing of said first and second components to form a combined mixture.

37. The mixing vial of claim 36, wherein said release mechanism comprises an elongate actuator rod extending sealingly through said septum, said rod being mounted for shifting between a non-actuating first position wherein said closure member maintains a closure position on said first end of said supplemental container and a second position engaging and forcing said closure member from said closure position.

38. A mixing vial for storing and mixing first and second components, said mixing vial comprising
a mixing container for holding said first component, said mixing container having first and second ends with an opening at its first end,
a septum sealing said first end,
a supplemental container received within said mixing container for holding the second component, said supplemental container having an open first end with a surrounding rim configured to rest in sealing engagement with an inwardly facing surface of said septum and a shoulder facing in the direction of the second end of said mixing container,
sealing mechanism comprising biasing mechanism in said mixing container engaging said shoulder on said supplemental container and yieldably biasing said supplemental container toward said septum with said rim held in sealing engagement with the septum to close said first end of the supplemental container preventing mixing of said first and second components, and
manually operable release mechanism movable between a non-operating first position wherein said sealing mechanism maintains closure of said first end of the supplemental container and an operating second position producing opening said first end of the supplemental container to permit mixing of said first and second components to form a combined mixture.

39. The mixing vial of claim 38, wherein said release mechanism comprises an elongate rigid release member manually shiftable between a non-operating first position which allows the supplemental container to remain in sealing contact with said septum and a second position engaging said supplemental container and shifting the supplemental container away from such sealing contact against the force of the biasing mechanism.

40. The mixing vial of claim 39, wherein said release member extends sealingly through said septum, into said supplemental container and on being shifted to its second position engages said supplemental container to move it to an open position.

41. The mixing vial of claim 40, wherein said release member comprises an elongate rigid rod having an inner end disposed within said mixing container and an outer end disposed outside the mixing container and a manually engagable actuator member is connected to the outer end of said rod, said actuator member being manually shiftable from a normally at rest position spaced from said septum toward said septum to move said rod from its first toward its second positions.

42. A mixing vial for storing and mixing first and second components, at least one of which components is a liquid, said mixing vial comprising
a mixing container for holding said first component, said mixing container having first and second ends with an opening at its first end,
a septum sealing said first end,
a liquid impermeable supplemental container received in said mixing container for holding the second component, said supplemental container having a rupturable portion, and
manually operable release mechanism movable between a non-operating first position wherein said supplemental container remains intact and a second position operable to break said rupturable portion of said supplemental container to permit mixing of said first and second components to form a combined mixture.

43. The mixing vial of claim 42, wherein said supplemental container is held in said mixing container with a first end adjacent said septum and a second end opposite said first end directed into said mixing container, said septum is flexible inwardly toward said mixing container, and said release mechanism comprises rupturing means interposed between said septum and said second end of said supplemental container operable to transmit force against and break said rupturable portion of said supplemental container upon inward flexing of said septum.

44. The mixing vial of claim 43, wherein said rupturing means comprises a member releasably held in said supplemental container with said second component and operable to enter said mixing container with said second component upon breaking of said supplemental container to act as an agitation device to assist mixing of said first and second components.

45. The mixing vial of claim 43, wherein said rupturing means comprises said second component held in said supplemental container positioned to be acted upon by flexing of said septum to transmit rupturing force to said rupturable portion of said supplemental container.

46. The mixing vial of claim 43, wherein said rupturing means comprises an elongate rigid rod extending between said septum and said second end of the supplemental container.

47. The mixing vial of claim 43, wherein said release mechanism comprises an actuator cap overlying said septum manually shiftable between a non-operating first position and an operating second position engaging said septum and flexing it inwardly.

48. The mixing vial of claim 47, wherein said actuator cap is mounted on said mixing container for movement in one direction for pressing inwardly on said septum and which has a protrusion on a portion thereof facing said septum operable to engage the septum and flex it inwardly on movement of said actuator cap in said one direction.

49. The mixing vial of claim 47, which further comprises a safety member shiftable between a safety position and a release position, said safety member being operable in said safety position to inhibit movement of said actuator cap from said first position to said second position and in said release position permits such movement of said actuator cap.

50. The mixing vial of claim 42, wherein said release mechanism comprises an elongate actuator rod extending sealingly through said septum, said rod being mounted for shifting between said first and second positions.

51. The mixing vial of claim 50, wherein said supplemental container is held in said mixing container with a first end adjacent said septum and a second end opposite said first end directed into said mixing container, and said rod in its second position transmits force against and breaks said rupturable portion of said supplemental container.

52. The mixing vial of claim 50, wherein said release mechanism comprises an actuator cap overlying said actuator rod, said actuator cap being manually shiftable between a non-operating first position and an operating second position engaging said actuator rod and shifting if from its first toward its second positions.

53. The mixing vial of claim 52, wherein said actuator cap is mounted on said mixing container for movement in one direction for pressing inwardly on said actuator rod.

54. The mixing vial of claim 53, which further comprises a safety member shiftable between a safety position and a release position operable in said safety position to inhibit-movement of said actuator cap from said first position to said second position, and in said release position permits such movement of said actuator cap.

55. A mixing vial for storing and mixing first and second components, at least one of which components is a liquid, said mixing vial comprising
a mixing container for holding said first component, said mixing container having first and second ends with an opening at its first end,
a septum sealing said first end and being manually flexible inwardly toward said mixing container,
a liquid impermeable supplemental container for holding the second component, said supplemental container being received in said mixing container with a first end adjacent said septum and a second end opposite said first end directed into said mixing container and having a rupturable portion directed into said mixing container, and
manually operable release mechanism movable between a non-operating first position which allows said supplemental container to remain intact and a second position operable to break said rupturable portion of said supplemental container to permit mixing of said first and second components to form a combined mixture, said release mechanism interposed between said septum and said second end of said supplemental container comprising said second component and a member releasably held in said supplemental container positioned to be acted upon by flexing of said septum to transmit rupturing force to said rupturable portion of said supplemental container, said member operable to enter said mixing container with said second component on breaking of said supplemental container to act as an agitation device to assist mixing of said first and second components.

56. The mixing vial of claim 55, wherein said release mechanism comprises an actuator cap overlying said septum manually shiftable between a non-operating first position and an operating second position engaging said septum and flexing it inwardly.

57. A mixing vial for storing and mixing first and second components, at least one of which components is a liquid, said mixing vial comprising
a mixing container for holding said first component, said mixing container having first and second ends with an opening at its first end,
a septum sealing said first end and being manually flexible inwardly toward said mixing container,
a liquid impermeable supplemental container for holding the second component, said supplemental container being received in said mixing container with a first end adjacent said septum and a second end opposite said first and having a rupturable portion directed into said mixing container, and
manually operable release mechanism movable between a non-operating first position which allows said supplemental container to remain intact and a second position operable to break said rupturable portion of said supplemental container to permit mixing of said first and second components to form a combined mixture, said release mechanism comprising an elongate rigid member releasably held in said supplemental container and extending between said septum and said second end of the supplemental container to be acted upon by flexing of said septum to transmit rupturing force to said rupturable portion of said supplemental container, said member operable to enter said mixing container with said second component on breaking of said supplemental container to act as an agitation device to assist mixing of said first and second components.

58. The mixing vial of claim 57, wherein said release mechanism comprises an actuator cap overlying said septum manually shiftable between a non-operating first position and an operating second position engaging said septum and flexing it inwardly.

59. A mixing vial for storing and mixing first and second components, at least one of which components is a liquid, said mixing vial comprising
a mixing container for holding said first component, said mixing container having first and second ends with an opening at its first end,
a septum sealing said first end,
a liquid impermeable supplemental container for holding the second component, said supplemental container being received in said mixing container with a first end adjacent said septum, a second end opposite said first end, and having a rupturable portion directed into said mixing container, and
manually operable release mechanism comprising an elongate actuator member extending sealingly through said septum and mounted for movement through said septum between a non-operating first position which allows said supplemental container to remain intact and a second position operable to transmit force against said second end of said supplemental container to break said rupturable portion to permit mixing of said first and second components to form a combined mixture.

60. The mixing vial of claim 59, wherein said release mechanism comprises an actuator cap overlying said actuator rod, said actuator cap being manually shiftable between a non-operating first position and an operating second position engaging said actuator rod

61. A mixing vial for storing and mixing first and second components comprising
a mixing container for holding said first component, said mixing container having a manually flexible side portion, and
a frangible supplemental container received within said mixing container for holding the second component, said supplemental container being positioned within said mixing container to be acted upon and broken by flexing of said side portion of said mixing container to permit mixing of said first and second components,

62. The mixing vial of claim 61, wherein said mixing container is elongate, having opposed first and second end portions, and said flexible side portion is disposed intermediate said first and second end portions.

63. The mixing vial of claim 62, wherein first and second end portions are disposed at a selected first angular position relative to each other when at rest and a central portion of said mixing container is flexible permitting bending of said end portions to a second angular position relative to each other.

64. The mixing vial of claim 63, wherein said supplemental container comprises an elongate ampoule positioned in said mixing container to be engaged by said mixing container end portions and broken when said end portions are bent from their first angular position to their second angular position.

65. The mixing vial of claim 64, wherein said ampoule has a weakened section intermediate opposed ends of the ampoule at which weakened section said ampoule breaks when said mixing container end portions are bent to their second angular position.

66. The mixing vial of claim 61, wherein said mixing container has a central portion intermediate opposed ends of the mixing container which is formed of a flexible material.

67. A mixing vial for storing and mixing first and second components comprising
a mixing container for holding said first component, said mixing container having a first portion and a second portion operatively connected for shifting relative to each other between an at rest first position and an operating second position, and
a supplemental container within said mixing container for holding the second component separated from said first component, said supplemental container being breakable to release said second component into said mixing container and being operatively mounted in said mixing chamber to remain intact when said first and second portions of said mixing container are in said first position and to be broken when said first and second portions are shifted to said second position.

68. The mixing vial of claim 67, wherein said supplemental container comprises separable first and second portions joined by a weakened section.

69. A mixing vial for storing and mixing first and second components comprising
a mixing container for holding said first component, the mixing container having a first portion and a second portion operatively connected for shifting relative to each other between an at rest first position and an operating second position, and
a supplemental container within said mixing container for holding the second component separated from said first component, said supplemental container comprising separable first and second portions which when intact hold said second component and when separated release said second component into said mixing container, said supplemental container being operatively mounted in said mixing chamber to remain intact when said first and second portions of said mixing container are in said first position and to be separated when said first and second portions are shifted to said second position.

70. Mixing apparatus for storing and mixing first and second components, said apparatus comprising
a mixing container for holding said first component,
a supplemental container received within said mixing container for holding the second component separated from said first component, said supplemental container having an open first end,
sealing mechanism operable to releasably hold said supplemental container in sealing engagement to seal said first end of the supplemental container to prevent mixing of said first and second components,
manually operable release mechanism operable to release said supplemental container from said sealing mechanism to permit mixing of said first and second components, and
restraining mechanism operable to inhibit return of said supplemental container to said sealing mechanism following release.

71. The mixing apparatus of claim 70, wherein said restraining mechanism comprises at least one restraining member connected to said supplemental container having a portion which is movable between a non-deployed position closely adjacent said supplement container when the supplemental container is held by said sealing mechanism and a deployed position spaced outwardly from said supplemental container.

72. The mixing apparatus of claim 71, wherein said member is yieldably biased to move from said non-deployed to said deployed position when said supplemental container is released from said sealing mechanism.

73. The mixing apparatus of claim 72, wherein a shoulder is formed in said mixing container and said restraining member in said deployed position is oriented to engage said shoulder to inhibit return of said supplemental container.

74. The mixing apparatus of claim 71, wherein said restraining mechanism comprises a plurality of restraining members connected to and arrayed circumferentially about said supplemental container and so oriented in their deployed positions as to engage an interior portion of said mixing container to inhibit engagement of said supplemental container with the mixing container upon shaking of the mixing container to mix the first and second components.

75. The mixing apparatus of claim 70, wherein said restraining mechanism comprises a base attached to said supplemental container and at least one elongate restraining member projecting from said base along one side of said supplemental container and movable between a non-deployed position closely adjacent said supplement container when the supplemental container is held by said sealing mechanism and a deployed position spaced outwardly from said supplemental container and said restraining member is yieldably biased toward said deployed position.

76. The mixing apparatus of claim 75, wherein said release mechanism is operable to shift said supplemental container in one direction within said mixing container away from said sealing mechanism and said restraining member extends from said base in the direction opposite said one direction.

77. The mixing apparatus of claim 76, wherein a shoulder is formed in said mixing container and said restraining member in its said deployed position is oriented to engage said shoulder to inhibit return of said supplemental container.

78. The mixing apparatus of claim 70, wherein said sealing mechanism comprises means releasably holding said first end of said supplemental container in sealing relationship.

79. The mixing apparatus of claim 70, wherein said supplemental container has a neck portion of selected configuration adjacent its first end and said sealing mechanism comprises a sealing member having a configuration complementary to said configuration of said neck portion operable to sealingly and releasably engage said neck portion.

80. The mixing apparatus of claim 79, wherein said mixing container has an opening at a first end thereof, and a cap seals said opening of said mixing container, said cap is flexible inwardly toward said mixing container and said release mechanism comprises an operator member interposed between said cap and supplemental container operable to shift said supplemental container from its position held by said sealing member upon flexing of said cap.

81. The mixing apparatus of claim 70, wherein said mixing container has an opening at a first end thereof, a cap seals said opening of said mixing container, said cap is flexible inwardly toward said mixing container, said sealing mechanism comprises means for releasably holding the first end of the supplemental container in sealing relationship, and said release mechanism comprises an operator member interposed between said cap and supplemental container operable to shift said supplemental container from its position held by said sealing member upon flexing of said cap.

82. The mixing apparatus of claim 81, wherein said cap comprises a septum which may be punctured to withdraw mixed component material from said mixing container and said operator member comprises a ring underlying said septum through which material may flow.

83. The mixing apparatus of claim 70, wherein said mixing container has an opening at a first end thereof, and a cap seals said opening of said mixing container, said cap comprises an elastomeric member having a normally outwardly projecting configuration and capable of being manually flexed inwardly toward said mixing container with such inward flexing resulting in release of said supplemental container from said sealing mechanism.

84. The mixing apparatus of claim 83, which further comprises an actuator overlying said cap and manually shiftable between a non-operating position and an operating position engaging said cap and flexing it inwardly.

85. The mixing apparatus of claim 84, which further comprises a safety member shiftable between a safety position and a release position, said safety member in said safety position operable to inhibit movement of said actuator from its said first position to said second position, and in said release position permits such movement of the actuator.

86. Mixing apparatus for storing and mixing first and second components, said apparatus comprising
a mixing container for holding said first component, said mixing container having first and second ends with an opening at its first end,
a supplemental container received within said mixing container for holding the second component separated from said first component, said supplemental container having an open first end,
sealing mechanism operable to releasably hold said supplemental container in sealing engagement to seal said first end of the supplemental container to prevent mixing of said first and second components,
a cap sealing at least a portion of said first end of the mixing container, said cap comprises an elastomeric member having a normally outwardly projecting configuration and capable of being manually flexed inwardly toward said mixing container with such inward flexing resulting in release of said supplemental container from said sealing mechanism, and
an actuator overlying said cap, said actuator being manually shiftable between a non-operating position permitting said cap to retain its outwardly projecting configuration and an operating position engaging said cap and flexing it inwardly.

87. The mixing apparatus of claim 86, which further comprises a safety member shiftable between a safety position and a release position, said safety member in said safety position operable to inhibit movement of said actuator from its said first position to said second position, and in said release position permits such movement of the actuator.

88. The mixing apparatus of claim 86, which further comprises an operator member interposed between said cap and supplemental container operable to shift said supplemental container from its position held by said sealing mechanism upon flexing of said cap.

89. The mixing apparatus of claim 88, wherein said operator member comprises a substantially rigid ring.

90. Mixing apparatus for storing and mixing first and second components, said apparatus comprising
a mixing container for holding said first component, said mixing container having first and second ends with an opening at its first end,
a cap sealing at least a portion of said first end of the mixing container, said cap comprises an elastomeric member having a normally outwardly projecting first position and capable of being manually flexed inwardly toward said mixing container to a second position,
a supplemental container received within said mixing container for holding the second component separated from said first component, said supplemental container having an open first end and a neck portion of selected configuration adjacent its first end,
sealing mechanism operable to hold said supplemental container in sealing engagement to seal said first end of the supplemental container to prevent mixing of said first and second components, said sealing mechanism comprising a pocket in said cap having a configuration complementary to said configuration of said neck portion operable to releasably engage said neck portion, and
a releasable crimp member on said cap tightened radially inward thereon to impart a radially inwardly directed force to produce a greater holding force on said supplemental container in said pocket.

91. The mixing apparatus of claim 90, wherein said crimp member comprises a holding portion inhibiting flexing of said cap from its first position to its second position; said holding portion being releasable to permit flexing of said cap toward its second position resulting in release of said supplemental container from said sealing mechanism.

92. The mixing apparatus of claim 91, wherein said crimp member comprises a tear-away element which may be manually removed from said cap to remove said radially inwardly directed force.

93. Mixing apparatus for storing and mixing first and second components, said apparatus comprising
a mixing container for holding said first component,
a supplemental container received in said mixing container for holding said second component separated from said first component, said supplemental container having an open first end,
sealing mechanism operable to releasably hold said supplemental container in sealing engagement to seal said first end to prevent mixing of the first and second components,
manually operable release mechanism operable to release said supplemental container from said sealing mechanism to permit mixing of said first and second components, and
restraining mechanism operable to inhibit return of said supplemental container to said sealing mechanism following release, said restraining mechanism comprising at least one restraining member coupled to said mixing container operable to engage said supplemental container when said supplemental container is released.

94. The apparatus of claim 93, wherein said supplemental container is movable along a release path on moving from its sealing position toward its release position and said restraining member has an engaging portion which is yieldably biased toward said path.

95. The apparatus of claim 94, wherein said restraining member extends into said release path and may be forced outwardly from said path by said supplemental container as the supplemental container moves from its sealing positions toward its release position.

96. The apparatus of claim 95, wherein said engaging portion is mounted for return movement into said path as said supplemental container passes said engaging portion on moving toward its release position.

97. The apparatus of claim 93, wherein said restraining mechanism comprises a plurality of restraining members coupled to said mixing container and arrayed circumferentially about said supplemental container when held in sealing engagement, said restraining members having engaging portions yieldably biased radially inwardly toward said supplemental container.

98. The apparatus of claim 97, wherein said restraining members are mounted to permit radially outward movement to allow said supplemental container to pass therebetween on moving along a release path from sealing engagement to release, and radially inward movement into said release path upon said supplemental container moving therepast to inhibit return of said supplemental container toward sealing engagement.

99. The apparatus of claim 93, wherein said mixing container has an open first end and an opposed second end, and which further comprises a septum sealing said first end, said septum comprising a puncturable seal to permit entry of a needle to withdraw a quantity of mixture resulting from mixing of said first and second components.

100. The apparatus of claim 99, wherein said septum comprises an elastomeric member.

101. The apparatus of claim 99, wherein said sealing mechanism comprises means for releasably holding the first end of said supplemental container in sealing relationship adjacent said septum.

102. The apparatus of claim 93, wherein said mixing container has a first open end and an opposed end and said restraining member is connected to said mixing container adjacent said first end and extends toward said second end.

103. The apparatus of claim 102, wherein said restraining member has a portion which is movable between a non-deployed position spaced laterally outwardly from a release path along which the supplemental container moves from its sealing position to its release position and a deployed position in said release path when the supplemental container is in its release position to inhibit return of said supplemental container to its sealing position.

104. The apparatus of claim 103, wherein said restraining member is yieldably biased to move from its non-deployed position to its deployed position.

105. The apparatus of claim 102, wherein said restraining mechanism comprises a base attached to a neck portion of said mixing container adjacent said one end and said restraining member is connected at one of its ends to said base and extends from said base toward said second end of the mixing container.

106. The apparatus of claim 105, wherein a plurality of elongate restraining members are connected adjacent one set of their ends to said base and are arrayed circumferentially about said supplemental container, with remainder portions of said restraining members extending from said base toward said second end of the mixing container.

107. The apparatus of claim 106, wherein said restraining members each have a portion which is movable between a non-deployed position spaced laterally outwardly from a release path along which the supplemental container moves from its sealing position to its release position and a deployed position in said release path when the supplemental container is in its release position to inhibit return of said supplemental container to its sealing position.
